(19) United States
(12) Patent Application Publication
(10) Pub. No.: US 2025/0369555 A1
(43) Pub. Date: Dec. 4, 2025

(54) THERMALLY INSULATED MULTILAYER TUBE FOR COOLANT

(71) Applicant: Martinrea International US Inc., Auburn Hills, MI (US)

(72) Inventor: Murali S. Chandrasekhar, Rochester, MI (US)

(21) Appl. No.: 19/219,115

(22) Filed: May 27, 2025

Related U.S. Application Data
(60) Provisional application No. 63/652,417, filed on May 28, 2024.

(51) Int. Cl. F16L 59/14; B32B 1/08; B32B 5/18; B32B 7/12; B32B 27/06; B32B 27/08; B32B 27/20; B32B 27/32; B32B 27/34; B32B 27/40; F16L 9/12; H01M 10/6568

(52) U.S. Cl. CPC F16L 59/143; B32B 1/08; B32B 5/18; B32B 7/12; B32B 27/065; B32B 27/08; B32B 27/20; B32B 27/32; B32B 27/34; B32B 27/40; F16L 9/12; B32B 2266/0257; B32B 2307/304; B32B 2597/00; H01M 10/6568

(57) ABSTRACT

A multi-layer coolant fluid transport tube having an inner layer including any of a polyamide, polypropylene impact copolymer or thermoplastic elastomer incorporating graphene, typically 0.01-60% by weight, thereby providing chemical resistance and a barrier to coolant loss. An outer layer including any of a polyamide, a polyethylene, a polypropylene, or a polyurethane material including the graphene along with a foaming agent for providing thermal insulation between a fluid contained in the tube and external surroundings. Additional variants include one or more intermediate layers having an anhydride modified polypropylene adhesive.

### CROSS REFERENCE TO RELATED APPLICATIONS

The present application claims priority from U.S. Ser. No. 63/652,417 filed May 28, 2024.

### FIELD OF THE INVENTION

The present invention relates generally to multilayer polymeric tubes providing barrier and chemical resistance to a fluid not limited to a coolant circulated through a battery pack such as incorporated into an electrical (EV) vehicle or like application. More specifically, the present invention teaches such an improved multilayer tube which reduces the heat transfer between the external environment and a coolant fluid that is the carried in the tubes.

### BACKGROUND OF THE INVENTION

The prior art teaches thermal management systems in BEV (battery electric vehicle) or PHEV (plug-in hybrid electric vehicles) which regulate the temperature of the battery pack to derive optimal performance. This is done by circulating a fluid through the battery pack to either heat or cool the battery cells. The fluid is transported to the battery pack through a web of tubes from the heat exchanger or chiller based on the system needs.

As is generally known, the optimal temperature for a battery pack to operate is between 25° C. to 32° C. Depending on the temperature of the battery pack, coolant either at lower or higher temperature is sent to the battery pack in an effort to maintain its temperature within the desired range. The coolant is either heated in a heater or cooled in a chiller to achieve the appropriate temperature and is then communicated to the battery pack through each of feed and return lines. As the coolant goes through the web of tube, it either losses or gain heat from the external environment. A challenge in the existing art has been in developing a tube with enhanced thermal insulating characteristics which reduces heat transfer to or from the external environment in order to provide efficient battery thermal management.

### SUMMARY OF THE INVENTION

The present invention discloses a multi-layer coolant fluid transport tube which can contain between two to five layers. An innermost layer can include any of a polyamide, polypropylene impact copolymer or thermoplastic elastomer incorporating Graphene and provides chemical resistance and a barrier to coolant loss. The Graphene further includes any Graphene derivative not limited to monolayer Graphene, few layered Graphene, Graphene oxide and reduced Graphene oxide. Additionally, the Graphene can be compounded with the inner layer at any suitable range or ratio, such as 0.01-60% by weight.

Optional middle layers can include such as an anhydride modified polypropylene which provides mechanical support, and which can further include one or more adhesion promoting layers to facilitate adhesion between dissimilar polymers incorporated into the inner and outer layers. An outermost layer includes a polyamide, Polyethylene, polypropylene, or polyurethane material with a foaming agent for providing thermal insulation between the fluid contained in the tube and the external surroundings. In a three layer construction, the outer layer will provide both mechanical support and insulation.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 presents a cutaway illustration of a two layer construction of the coolant fluid transport tube which includes an inner layer having a polyamide or polyethylene with graphene along with an outer polyamide layer with a foaming agent;

FIG. 2 is a cutaway illustration of a three layer construction of the coolant fluid transport tube which includes an inner layer having a polyamide or polyethylene with graphene, an anhydride modified polypropylene adhesive intermediate layer along and an outer polyamide with graphene or a polyethylene or polypropylene layer with a foaming agent;

FIG. 3 is a cutaway illustration of a four layer construction of the coolant fluid transport tube which includes an inner layer having any of a polypropylene impact copolymer or polypropylene with graphene, a thermoplastic elastomer or thermoplastic elastomer graphene composite, an anhydride modified polypropylene adhesive first intermediate layer, a second intermediate layer including a polyamine with graphene and an outer layer including any of a polyamide, polyethylene or polypropylene with a foaming agent; and

FIG. 4 is a cutaway illustration of a five layer construction of the coolant fluid of the coolant fluid transport tube which includes an inner layer having any of a thermoplastic elastomer or a thermoplastic elastomer and graphene composite, an innermost intermediate second layer having a polypropylene impact copolymer graphene composite, a third intermediate layer anhydride modified polypropylene adhesive layer, a fourth intermediate layer including a polyamine with graphene and an outermost fifth layer including any of a polyamide, polyethylene or polypropylene with a foaming agent.

### DETAILED DESCRIPTION OF THE PREFERRED EMBODIMENTS

With reference to the attached illustrations, the present invention discloses an improved multilayer tube which reduces the heat transfer between the external environment and a coolant fluid that is the carried in the tubes. As previously disclosed, the present invention discloses a multi-layer coolant fluid transport tube which can contain between two to five layers.

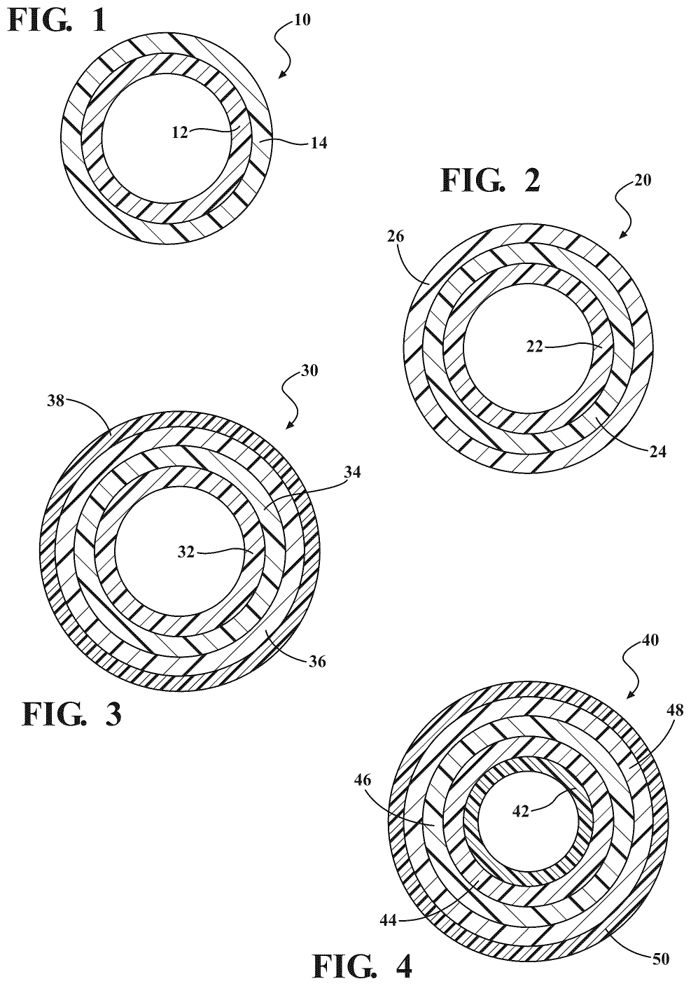

FIG. 1 presents a cutaway illustration at 10 of a two-layer construction of the coolant fluid transport, and tube which includes an inner layer 12 having a polyamide or polyethylene with graphene along with an outer polyamide layer 14 with a foaming agent. Without limitation, the first layer 12 can include any of a variety of polyamides including PA612, PA12, PA11, PA10, PA6, PA610, PA1012, or PA612 with graphene (0.01-60% by weight), a PA12 with graphene (0.01-60% by weight), a PA11 with graphene (0.01-60% by weight), a PA10 with graphene (0.01-60% by weight), a PA6 with graphene (0.01-60% by weight), a PA610 with graphene (0.01-60% by weight), or a PA1012 with graphene (0.01-60% by weight).

The second layer 14 further includes any of a polyamide with foaming agent; the polyamide including any of a PA612, PA12, PA11, PA10, PA6, PA610, PA1012, PA612 with graphene (0.01-60% by weight), a PA12 with graphene (0.01-60% by weight), a PA11 with graphene (0.01-60% by weight), a PA10 with graphene (0.01-60% by weight), a PA6 with graphene (0.01-60% by weight), a PA610 with graphene (0.01-60% by weight), a PA1012 with graphene (0.01-60% by weight). Alternatively, the outer layer 14 can include a polyethylene, a polypropylene or polyurethane, in each instance with a foaming agent.

Addressing further the polyamide materials, PolyMide™ PA612-CF is a carbon fiber reinforced polyamide filament based on a copolymer of PA6 and PA12. Thanks to its chemical structure, this product has lower moisture sensitivity compared to PA6/66 and PA6-based materials, and better mechanical properties than PA12-based materials.

PA 12, also Nylon 12, Nylon 12 is a nylon polymer with the formula [(CH2)11C(O)NH]ₙ. It is made from ω-aminolauric acid or laurolactam monomers that each have 12 carbons, hence the name ‘Nylon 12’. It is one of several nylon polymers.

PA11, also Nylon 11 or Polyamide 11 (PA 11) is a polyamide, bioplastic and a member of the nylon family of polymers produced by the polymerization of 11-aminoundecanoic acid. It is produced from castor beans by Arkema under the trade name Rilsan.

PA10, also known as Polyamide 10.10 (PA1010) is a semi crystalline polymer with emerging applications in industry due to its promising mechanical properties and relatively low melting temperature.

PA6, also known at Nylon 6 or polycaprolactam is a polymer, in particular a semicrystalline polyamide. Unlike most other nylons, nylon 6 is not a condensation polymer, but instead is formed by ring-opening polymerization.

Polyamide 610 (PA 610, Nylon 610) is a copolymer of Nylon 6 and Nylon 10 and therefore offers a balance between the properties of Nylon 6 and Nylon 10. Key characteristics of Nylon 610 include a high bio-content, low water absorption, good dimensional stability, good chemical resistance, and good processability.

Aliphatic polyamide 1012 (PA1012) is a poly-condensation product of DMDA and 1,12-dodecanedioic acid. The C12 dicarboxylic acid is typically fossil-based, being the bio-based content of PA1012 approximately 45 wt.-%.

Finally, polyamide 612 (PA 612) is a polycondensation product of 1,6-hexamethylenediamine and 1,12-dodecanedioic acid (1,10-decane dicarboxylic acid). Although the carbonamide group concentration is slightly higher than in polyamide 12, it is significantly lower than in polyamide 6 or polyamide 66.

Referring to FIG. 2, a cutaway illustration is generally shown at 20 of a three layer construction of the coolant fluid transport tube, and which includes an inner layer 22 having a polyamide or polyethylene with graphene, an anhydride modified polypropylene adhesive intermediate layer 24 along and an outer polyamide with graphene or a polyethylene or polypropylene layer, collectively referenced at 26, with a foaming agent.

The first layer 22 more specifically includes any of a polypropylene impact copolymer which may also be Polypropylene graphene (0.01-60% by weight) composite. Alternatively, the first layer 22 includes either of a thermoplastic elastomer (TPE) or a thermoplastic elastomer graphene (0.01-60% by weight) composite. The second intermediate layer 24 again includes an anhydride modified polypropylene adhesive layer.

The third outer layer 26 includes a polyamide with a foaming agent, such as any of a PA612, PA12, PA11, PA10, PA6, PA610, PA1012, or a PA612 with graphene (0.01-60%). Other options includes a PA12 with graphene (0.01-60% by weight), a PA11 with graphene (0.01-60% by weight), a PA10 with graphene (0.01-60% by weight), a PA6 with graphene (0.01-60% by weight), a PA610 with graphene (0.01-60% by weight), a PA1012 with graphene (0.01-60% by weight). Other options for the outer layer 26 again include any of a polyethylene, polypropylene or polyurethane, in each instance with a foaming agent.

FIG. 3 presents, generally at 30, a cutaway illustration of a four layer construction of the coolant fluid transport tube which includes an inner layer 32 having any of a polypropylene impact copolymer or polypropylene with graphene, a thermoplastic elastomer or thermoplastic elastomer graphene composite, an anhydride modified polypropylene adhesive initial intermediate layer 34, a second intermediate layer 36 including a polyamine with graphene and an outer layer 38 including any of a polyamide, polyethylene or polypropylene with a foaming agent. The inner layer 32 again specifically includes the polypropylene impact copolymer also including a polypropylene with graphene (0.01-60% by weight) composite, a thermoplastic elastomer (TPE), or a thermoplastic elastomer graphene (0.01-60% by weight) composite.

The polyamide included in the second intermediate layer 36 may be a PA612, PA12, PA11, PA10, PA6, PA610, PA1012, or PA612 with graphene (0.01-60% by weight), a PA12 with graphene (0.01-60% by weight), a PA11 with graphene (0.01-60% by weight), a PA10 with graphene (0.01-60% by weight), a PA6 with graphene (0.01-60% by weight), or a PA610 with graphene (0.01-60% by weight), PA1012 with graphene (0.01-60% by weight). The outer layer 38 having the polyamide with the foaming agent further again includes any of a PA612, PA12, PA11, PA10, PA6, PA610, PA1012, or PA612 with graphene (0.01-60% by weight), a PA12 with graphene (0.01-60% by weight), a PA11 with graphene (0.01-60% by weight), a PA10 with graphene (0.01-60% by weight), a PA6 with graphene (0.01-60% by weight), a PA610 with graphene (0.01-60% by weight), a PA1012 with graphene (0.01-60% by weight). Separately, the outer layer 38 can be provided with any of a polyethylene, polypropylene or polyurethane with a foaming agent.

Finally, FIG. 4 presents a cutaway illustration generally at 40 of a five layer construction of the coolant fluid of the coolant fluid transport tube, and which includes an inner layer 42 having any of a thermoplastic elastomer or a thermoplastic elastomer and graphene (0.01-60% by weight) composite, an innermost intermediate second layer 44 having a polypropylene impact copolymer graphene (0.01-60% by weight) composite, a third intermediate layer 46 having an anhydride modified polypropylene adhesiver, a fourth intermediate layer 48 including a polyamine with graphene, and an outermost fifth layer 50 including any of a polyamide, polyethylene or polypropylene, each again with a foaming agent.

The polyamide in the fourth layer 48 can include any of a PA612, PA12, PA11, PA10, PA6, PA610, PA1012, or PA612 with graphene (0.01-60% by weight), as well as a PA12 with graphene (0.01-60% by weight), a PA11 with graphene (0.01-60% by weight), a PA10 with graphene (0.01-60% by weight), a PA6 with graphene (0.01-60% by weight), a PA610 with graphene (0.01-60% by weight), or a PA1012 with graphene (0.01-60% by weight).

The polyamide variants of the fifth outermost layer 50 include any of a PA612, PA12, PA11,PA10, PA6, PA610, PA1012, PA612 with graphene (0.01-60% by weight), a PA12 with graphene (0.01-60% by weight), a PA11 with graphene (0.01-60% by weight), a PA10 with graphene (0.01-60% by weight), a PA6 with graphene (0.01-60% by weight), a PA610 with graphene (0.01-60% by weight), a

PA1012 with graphene (0.01-60% by weight). The fifth layer 50, as previously described, may also include any of a polyethylene, polypropylene or polyurethane with a foaming agent.

In each of the preceding embodiments, the Graphene further includes any Graphene derivative not limited to monolayer Graphene, few layered Graphene, Graphene oxide and reduced Graphene oxide. Additional variants also contemplate any of a micro-level or no level of Graphene additive incorporated into the various layers.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A multi-layer coolant fluid transport tube, comprising:
an inner layer including any of a polyamide, a polypropylene impact copolymer or a thermoplastic elastomer incorporating a Graphene for providing chemical resistance and a barrier to coolant loss; and
an outer layer including any of a polyamide, a polyethylene, a polypropylene, or a polyurethane material with a foaming agent for providing thermal insulation between a fluid contained in the tube and external surroundings.

2. The transport tube of claim 1, further comprising incorporating said Graphene into said outer layer.

3. The transport tube of claim 2, said Graphene being provided in a range of 0.01-60% by weight in said inner or outer layers.

4. The transport tube of claim 1, said polyamide further comprising any of a PA612, PA12, PA11, PA10, PA6, PA610, PA1012, or PA612.

5. The transport tube of claim 1, further comprising at least one intermediate layer including at least an anhydride modified polypropylene adhesive layer.

6. The transport tube of claim 5, said at least one intermediate layer further comprising a polypropylene impact copolymer.

7. The transport tube of claim 5, said at least one intermediate layer further comprising said Graphene provided in a range of 0.01-60% by weight in said intermediate layer.

8. The transport tube of claim 5, said at least one intermediate layer further comprising a polypropylene impact copolymer.

9. The transport tube of claim 5, said at least one intermediate layer further comprising a polyamide with a foaming agent.

10. The transport tube of claim 1, said Graphene further including any Graphene derivative not limited to monolayer Graphene, few layered Graphene, Graphene oxide and reduced Graphene oxide.

11. A multi-layer coolant fluid transport tube, comprising:
an inner layer including any of a polyamide, a polypropylene impact copolymer or a thermoplastic elastomer providing chemical resistance and a barrier to coolant loss; and
an outer layer including any of a polyamide, a polyethylene, a polypropylene, or a polyurethane material with a foaming agent for providing thermal insulation between a fluid contained in the tube and external surroundings.

12. The transport tube of claim 11, further comprising at least one of said inner and outer layers incorporating a Graphene.

13. The transport tube of claim 12, said Graphene being provided in a range of 0.01-60% by weight relative to said inner or outer layers.

14. The transport tube of claim 11, said polyamide further comprising any of a PA612, PA12, PA11, PA10, PA6, PA610, PA1012, or PA612.

15. The transport tube of claim 11, further comprising at least one intermediate layer including at least an anhydride modified polypropylene adhesive layer.

16. The transport tube of claim 15, said at least one intermediate layer further comprising a polypropylene impact copolymer.

17. The transport tube of claim 15, said at least one intermediate layer further comprising said graphene provided in a range of 0.01-60% by weight in said intermediate layer.

18. The transport tube of claim 15, said at least one intermediate layer further comprising a polypropylene impact copolymer.

19. The transport tube of claim 15, said at least one intermediate layer further comprising a polyamide with a foaming agent.

20. The transport tube of claim 15, said Graphene further including any Graphene derivative not limited to monolayer Graphene, few layered Graphene, Graphene oxide and reduced Graphene oxide.
